(19) United States
(12) Patent Application Publication
(10) Pub. No.: US 2009/0314417 A1
(43) Pub. Date: Dec. 24, 2009

(54) METHOD OF GRINDING BACK SIDE OF SEMICONDUCTOR WAFER AND ADHESIVE SHEET FOR USE IN THE METHOD OF GRINDING BACK SIDE OF SEMICONDUCTOR WAFER

(75) Inventors: Takatoshi SASAKI, Osaka (JP); Toshio SHINTANI, Osaka (JP); Fumiteru ASAI, Osaka (JP); Akiyoshi YAMAMOTO, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/487,718

(22) Filed: Jun. 19, 2009

(30) Foreign Application Priority Data
Jun. 20, 2008 (JP) 2008-161396

(51) Int. Cl. B32B 38/10; C08K 5/521

(52) U.S. Cl. 156/154; 524/145

(57) ABSTRACT

The present invention provides a method of grinding a back side of a semiconductor wafer, which includes applying an adhesive sheet including a substrate and an adhesive layer formed on one side of the substrate to a front side of a semiconductor wafer to provisionally fix the semiconductor wafer to the adhesive sheet, followed by grinding the back side of the semiconductor wafer, in which the adhesive layer contains 100 parts by weight of a base polymer for radiation-curable adhesives, 0.02 to 10 parts by weight of a phosphoric ester compound having an alkyl group having 10 or more carbon atoms, and more than 10 parts by weight but 200 parts by weight or less of at least one polyfunctional acrylate oligomer and/or monomer having one or more carbon-carbon double bonds, the polyfunctional acrylate oligomer and/or monomer having a weight-average molecular weight per carbon-carbon double bond of 250 to 6,500.

### FIELD OF THE INVENTION

The present invention relates to a method of grinding back side of semiconductor wafer which has a surface with irregularities, and to an adhesive sheet for use in the method of grinding back side of semiconductor wafer.

### BACKGROUND OF THE INVENTION

In a back grinding step in which the back side of a semiconductor wafer having a front side with irregularities attributable to a circuit pattern or the like (pattern surface) is ground, it is necessary to protect the pattern surface in order to prevent the pattern surface irregularities from being damaged or being contaminated with a grinding dust, grinding water, etc. Furthermore, there is a problem that because the semiconductor wafer itself is thin and brittle after grinding and because the pattern surface of the semiconductor wafer has irregularities, the semiconductor wafer is apt to break upon reception of even a slight external force.

A known method for protecting the pattern surface and preventing wafer breakage in such semiconductor wafer back grinding is to apply an adhesive sheet such as a back grinding tape to the circuit-pattern-bearing side of the semiconductor wafer in the step of back grinding.

In recent years, the pattern surfaces of semiconductor wafers are coming to have a larger height difference in irregularities. For example, in wafers having a polyimide film, the height difference in irregularities is about from 1 μm to 20 μm. Defective-indicating marks (bad marks) for indicating defective semiconductor chips have irregularities with a difference in height of about from 10 μm to 50 μm.

Furthermore, there are wafers having a pattern including copper electrodes having a height of about from 10 μm to 30 μm arranged at a fine pitch. Namely, the shapes and roughness of wafer surfaces have been diversified. In the methods employing known adhesive sheets, the adhesive sheets cannot conform to such irregularities and there are cases where adhesion between the adhesive and the wafer surface becomes insufficient. As a result, there are cases where sheet peeling, penetration of grinding water or foreign substances onto the pattern surface, processing failures, dimple formation, or breakage occurs during wafer processing.

Accordingly, there are increasing cases where an adhesive sheet for protection having an adhesive layer with an increased thickness or employing a soft adhesive is used as a back grinding tape in processing such a semiconductor wafer, in order to facilitate conformation to the pattern with irregularities in tape application. Examples of such adhesive sheets include an adhesive sheet for semiconductor wafer holding/protection which includes a substrate, an interlayer formed on one side of the substrate and having a modulus at 25° C. of from 10 kPa to 1,000 kPa and a gel content of 26% to 45%, and an adhesive layer formed on the surface of the interlayer (see, JP-A-2005-303068). However, some of the recent wafers having irregularities have a surface partly having fine roughness. When an adhesive sheet is applied to such a wafer surface, the adhesive penetrates into the fine irregularities in the wafer surface and, hence, sheet stripping is apt to result in an adhesive residue due to physical bonding. This has posed a problem that yield in the production stage decreases considerably.

### SUMMARY OF THE INVENTION

An object of the invention is to provide a method of semiconductor wafer back grinding (herein, it may be also referred to as a method of grinding back side of semiconductor wafer), in which an adhesive sheet is applied to a wafer surface (front side) having a pattern with irregularities and having fine surface roughness to provisionally fix the wafer to the adhesive sheet and the back side of this wafer is ground while preventing sheet peeling, penetration of grinding water or foreign substances onto the pattern surface, processing failures, dimple formation, wafer breakage, etc., and which is free from leaving an adhesive residue when the adhesive sheet is stripped from the wafer surface after completion of back grinding. Another object of the invention is to provide an adhesive sheet for use in the method of semiconductor wafer back grinding.

Namely, the invention provides a method of grinding a back side of a semiconductor wafer, which comprises applying an adhesive sheet comprising a substrate and an adhesive layer formed on one side of the substrate to a front side of a semiconductor wafer to provisionally fix the semiconductor wafer to the adhesive sheet, followed by grinding the back side of the semiconductor wafer, wherein the adhesive layer comprises 100 parts by weight of a base polymer for radiation-curable adhesives, 0.02 to 10 parts by weight of a phosphoric ester compound having an alkyl group having 10 or more carbon atoms, and more than 10 parts by weight but 200 parts by weight or less of at least one polyfunctional acrylate oligomer and/or monomer having one or more carbon-carbon double bonds, the polyfunctional acrylate oligomer and/or monomer having a weight-average molecular weight per carbon-carbon double bond of 250 to 6,500.

Due to the incorporation of the phosphoric ester compound having an alkyl group with 10 or more carbon atoms into a radiation-curable adhesive in an amount within the given range, even when a semiconductor wafer having a surface (front side) with irregularities, e.g., a circuit pattern, and fine recesses and protrusions formed by vapor deposition or the like is used as the adherend, the adhesive sheet can satisfactorily retain initial adhesive force as an adhesive sheet for fixing and enables an adherend in a sufficiently fixed state to be subjected to back grinding. Consequently, according to the method of back grinding of the invention, the back side of a semiconductor wafer as an adherend can be ground with satisfactory workability without lowering yield, regardless of the surface state of the adherend, and the adhesive sheet can be satisfactorily stripped from the adherend after the back grinding.

In the radiation-curable adhesive layer, the phosphoric ester compound having an alkyl group with 10 or more carbon atoms is thought to form a kind of non-adhesive filmy substance discontinuously on the surface of the adhesive layer upon irradiation with a radiation to thereby impart satisfactory strippability to the adhesive sheet. It is also thought that since the phosphoric ester compound has an alkyl group having 10 or more carbon atoms, the radiation-curable adhesive layer can retain the intact initial adhesive force thereof. In case where the alkyl group of the phosphoric ester compound has less than 10 carbon atoms, initial adhesive force is insufficient.

The adhesive layer contains the phosphoric ester compound having an alkyl group with 10 or more carbon atoms in an amount of from 0.02 parts by weight to 10 parts by weight, preferably from 0.05 parts by weight to 2 parts by weight, per 100 parts by weight of the base' polymer. When the content of the phosphoric ester compound having an alkyl group with 10 or more carbon atoms is within that range, the effects of the addition thereof can be obtained and initial adhesive force can be ensured before ultraviolet irradiation. In addition, compatibility with the adhesive can be ensured and the adhesive layer can hence be prevented from contaminating the adherend surface upon stripping therefrom.

The adhesive layer is constituted of an adhesive capable of undergoing a polymerization curing reaction by the action of ultraviolet and/or a radiation. A suitable adhesive layer is one formed using at least one polyfunctional acrylate oligomer and/or monomer having one or more carbon-carbon double bonds. This polyfunctional acrylate oligomer and/or monomer has a weight-average molecular weight per carbon-carbon double bond of 250 to 6,500, preferably 500 to 4,000. When the weight-average molecular weight thereof per carbon-carbon double bond is within that range, the adhesive layer can be satisfactorily cured and shrunk by irradiation with a radiation. Accordingly, the adhesive sheet can be applied to adherend surfaces having a wide variety of irregularities and can be prevented from destroying the irregularities or leaving an adhesive residue among the irregularities upon stripping.

This polyfunctional acrylate oligomer and/or monomer is contained in an amount of more than 10 parts by weight but 200 parts by weight or less, per 100 parts by weight of the base polymer. When the content thereof is within this range, the desired curing and shrinkage of the adhesive by irradiation with a radiation are obtained. In addition, this adhesive layer can be prevented from undergoing the compositional change with time which is attributable to oligomer proportion in the adhesive layer, whereby long-lasting stable quality can be obtained.

In the method of semiconductor wafer back grinding according to the invention, the phosphoric ester compound contained in the adhesive layer preferably has a linear alkyl group having 15 to 60 carbon atoms.

When the phosphoric ester compound has a linear alkyl group with 15 or more carbon atoms, this phosphoric ester compound can have a higher melting point. From the standpoints of industrial availability, the range of molecular weight distribution, heat resistance, etc., it is preferred that the number of carbon atoms in the linear alkyl group be 60 or smaller.

In the method of semiconductor wafer back grinding according to the invention, the phosphoric ester compound contained in the adhesive layer preferably has a melting point of 40° C. to 110° C.

When the phosphoric ester compound has a melting point of 40° C. or higher, this compound can be stably present even in high-temperature storage or long-term storage. Even when an adhesive sheet for fixing which contains that compound in the adhesive layer is applied to an adherend and subjected to high-temperature storage or long-term storage, the force of adhesion therebetween is inhibited from increasing. The reason why the melting point of the phosphoric ester compound is preferably 110° C. or lower is that 110° C. is an upper limit from the standpoint of heat resistance.

In the method of semiconductor wafer back grinding according to the invention, the front side of the semiconductor wafer may have a pattern having irregularities with a height difference of from 1 μm to 30 μm and has fine recesses and protrusions having a surface roughness of from 30 nm to 100 nm.

The present invention further provides an adhesive sheet for use in the method of semiconductor wafer back grinding.

### DETAILED DESCRIPTION OF THE INVENTION

The adhesive sheet for semiconductor wafer back grinding according to the invention is constituted mainly of a substrate and an adhesive layer. The substrate to be used in the invention is not particularly limited so long as the substrate transmits ultraviolet and/or a radiation. For example, a substrate which transmits at least part of radiations including ultraviolet, X-rays, and electron beams may be used. For example, a substrate having a transmission of about 75% or higher, preferably about 80% or higher, more preferably about 90% or higher, is preferred. Examples of the substrate include ones made of poly(vinyl chloride), poly(vinylidene chloride), polyesters such as poly(ethylene terephthalate), polyimides, and polyetheretherketones; polyolefins such as low-density polyethylene, linear polyethylene, medium-density polyethylene, high-density polyethylene, ultralow-density polyethylene, random polypropylene copolymers, block polypropylene copolymers, propylene homopolymer, polybutene, and polymethylpentene; and polymers such as polyurethanes, ethylene/vinyl acetate copolymers, ionomer resins, ethylene/(meth)acrylic acid copolymers, ethylene/(meth)acrylic ester (random or alternating) copolymers, ethylene/butene copolymers, ethylene/hexene copolymers, fluororesins, cellulosic resins, and polymers obtained by crosslinking these polymers. Such substrates may be constituted of a single layer or have a multilayer structure. A suitable range of the thickness of the substrate is generally about from 5 μm to 400 μm. Preferably, the thickness thereof is from 20 μm to 300 μm.

The adhesive layer to be formed on the substrate is one constituted of an adhesive capable of undergoing a polymerization curing reaction by the action of ultraviolet and/or a radiation. This adhesive layer is not limited at all so long as the adhesive layer contains 100 parts by weight of a base polymer for radiation-curable adhesives, 0.02 to 10 parts by weight of a phosphoric ester compound having an alkyl group having 10 or more carbon atoms, and more than 10 parts by weight but 200 parts by weight or less of at least one polyfunctional acrylate oligomer and/or monomer having one or more carbon-carbon double bonds, the polyfunctional acrylate oligomer and/or monomer having a weight-average molecular weight per carbon-carbon double bond of 250 to 6,500, preferably 500 to 4,000.

The adhesive layer in the invention can be formed using a pressure-sensitive adhesive in general use. An adhesive containing a compound having functional groups curable with ultraviolet and/or a radiation, such as carbon-carbon double bonds, as a base polymer is suitable.

As the base polymer, one or more base polymers for known adhesives can be suitably selected and used. Preferred examples thereof include polymers such as acrylic polymers or elastomers, e.g., acrylic polymers obtained by copolymerizing (meth)acrylic acid or an ester thereof with one or more monomers copolymerizable with the (meth)acrylic acid or the ester thereof, and natural or synthetic rubbers. The molecular weight (weight-average molecular weight) of the base polymer is preferably 300,000 to 1,500,000, more preferably 300,000 to 1,100,000. When a base polymer having a molecular weight (weight-average molecular weight) within that range is used, satisfactory compatibility with a tackifier and other additive ingredients can be obtained.

Examples of the copolymerizable monomers for constituting the base polymer include various monomers such as hydroxyalkyl esters of (meth)acrylic acid (e.g., the hydroxyethyl ester, hydroxybutyl ester, and hydroxyhexyl ester); the glycidyl ester of (meth)acrylic acid; carboxyl-group-containing monomers such as acrylic acid, methacrylic acid, carboxyethyl(meth)acrylate, carboxypentyl(meth)acrylate, itaconic acid, maleic acid, fumaric acid, and crotonic acid; acid anhydride monomers such as maleic anhydride and itaconic anhydride; (meth)acrylamide; N-hydroxymethyl(meth)acrylamide; alkylaminoalkyl esters of (meth)acrylic acid (e.g., dimethylaminoethyl methacrylate and t-butylaminoethyl methacrylate); N-vinylpyrrolidone; acryloylmorpholine; vinyl acetate; styrene; acrylonitrile; N,N-dimethylacrylamide; and monomers having a side chain including an alkoxyl group, e.g., methoxyethyl(meth)acrylate and ethoxyethyl(meth)acrylate. These copolymerizable monomers may be used alone or as a mixture of two or more thereof.

Especially when an acrylic polymer is used as the base polymer in the invention, a crosslinking agent may be added at will. The crosslinking agent causes the base polymer to undergo three-dimensional crosslinking and can thereby impart more sufficient cohesive force to the adhesive layer. Examples of the crosslinking agent include polyisocyanate compounds, polyglycidyl compounds, aziridine compounds, melamine compounds, and polyvalent-metal chelate compounds. When such a compound is incorporated, the proportion thereof is preferably in the range of from 0.01 part by weight to 10 parts by weight, especially from 0.03 parts by weight to 7 parts by weight, per 100 parts by weight of the base polymer. By incorporating the compound in that proportion, not only cohesive force can be ensured but also the contamination of semiconductor substrates caused by an excess crosslinking agent can be avoided.

Examples of the elastomer to be used as the base polymer include natural rubber, synthetic isoprene rubber, styrene/butadiene rubbers, styrene/butadiene/styrene block copolymers, styrene/isoprene/styrene block copolymers, butyl rubber, polyisobutylene, polybutadiene, poly(vinyl ether), silicone rubbers, poly(vinyl isobutyl ether), vinyl acetate polymers, chloroprene rubber, nitrile rubbers, graft rubbers, regenerated rubbers, styrene/ethylene/butylene block copolymers, styrene/propylene/butylene block copolymers, styrene/isoprene copolymers, acrylonitrile/butadiene copolymers, acrylonitrile/acrylic ester copolymers, methyl methacrylate/butadiene copolymers, polyisobutylene/ethylene/propylene copolymers, ethylene/vinyl acetate copolymers, and acrylic rubbers (alkyl acrylate copolymers and alkyl acrylate/alkoxyalkyl acrylate copolymers).

A phosphoric ester compound having an alkyl group with 10 or more carbon atoms is incorporated as a surfactant into the radiation-curable adhesive to be used in the invention. The alkyl group of the phosphoric ester compound preferably has 15 or more carbon atoms. Although the alkyl group of the phosphoric ester compound may be either linear or branched, it is preferred that the alkyl group should be a linear alkyl group because this group imparts a higher melting point to the phosphoric ester compound. Incidentally, a substantial upper limit of the number of carbon atoms therein is about 50 to 60 from the standpoints of industrial availability, the range of molecular weight distribution, heat resistance (the upper limit of melting point is about 110° C.), etc.

This phosphoric ester compound has a melting point of preferably 40° C. or higher. The phosphoric ester compound having such a melting point can be stably present even in high-temperature storage or long-term storage. Even when an adhesive sheet for fixing which contains that compound in the adhesive layer is applied to an adherend and subjected to high-temperature storage or long-term storage, the force of adhesion therebetween is inhibited from increasing.

Examples of the phosphoric ester compound include ester compounds (monoesters, diesters, and triesters) of a higher alcohol having an alkyl group having 10 or more, preferably 15 or more carbon atoms with phosphoric acid. Preferred of these is a monoester, diester, or triester of the higher alcohol with phosphoric acid. The ester compound of the higher alcohol with phosphoric acid can be produced by dehydrating the higher alcohol and the phosphoric acid in an organic solvent with heating and refluxing in the presence of an acid catalyst, e.g., hydrochloric acid.

Examples of the higher alcohol include stearyl alcohol (number of carbon atoms, 18), docosanol-1 (number of carbon atoms, 22), tetracosanol-1 (number of carbon atoms, 24), hexacosanol-1 (number of carbon atoms, 26), octacosanol-1 (number of carbon atoms, 28), nonacosanol-1 (number of carbon atoms, 29), myricyl alcohol (number of carbon atoms, 30), melissyl alcohol (number of carbon atoms, 31), lacceryl alcohol (number of carbon atoms, 32), cellomelissyl alcohol (number of carbon atoms, 33), tetratriacontanol-1 (number of carbon atoms, 34), heptatriacontanol-1 (number of carbon atoms, 35), and tetratetracontanol-1 (number of carbon atoms, 44).

The phosphoric ester compound is incorporated in an amount of from 0.02 parts by weight to 10 parts by weight per 100 parts by weight of the base polymer of the radiation-curable adhesive. The amount thereof is preferably from 0.05 parts by weight to 2 parts by weight. Such amounts of the phosphoric ester compound to be incorporated are on a solid basis. In case where the amount of the phosphoric ester compound incorporated is smaller than 0.02 parts by weight, substantially no effect of the addition thereof can be expected. From the standpoint of the effect of the addition of the phosphoric ester compound, the amount of the compound to be incorporated is preferably 0.05 parts by weight or larger. On the other hand, in case where the amount of the phosphoric ester compound incorporated is larger than 10 parts by weight, the resultant adhesive has low initial adhesive force before irradiation with ultraviolet and cannot be expected to function as an adhesive. In addition, the phosphoric ester compound incorporated in such a large amount has poor compatibility with the adhesive and there are cases where this compound contaminates the adherend surface upon the stripping of the adhesive sheet. From this standpoint, the amount of the phosphoric ester compound to be incorporated is preferably regulated to 5 parts by weight or smaller, in particular, 2 parts by weight or smaller.

The adhesive layer formed on the substrate is constituted of an adhesive capable of undergoing a polymerization curing reaction by the action of ultraviolet and/or a radiation. A suitable adhesive layer is one formed using at least one polyfunctional acrylate oligomer and/or monomer having one or more carbon-carbon double bonds. This polyfunctional acrylate oligomer and/or monomer has a weight-average molecular weight per carbon-carbon double bond of 250 to 6,500, preferably 500 to 4,000. When the weight-average molecular weight thereof per carbon-carbon double bond is within that range, the adhesive layer can be satisfactorily cured and shrunk to a desired hardness by irradiation with a radiation. Accordingly, the adhesive sheet can be applied to adherend surfaces having a wide variety of irregularities and can be prevented from destroying the irregularities or leaving an adhesive residue among the irregularities upon stripping.

This polyfunctional acrylate oligomer and/or monomer is contained in an amount of more than 10 parts by weight but 200 parts by weight or less per 100 parts by weight of the base polymer. When the content thereof is within this range, the desired curing and shrinkage of the adhesive by irradiation with a radiation are obtained. In addition, this adhesive layer can be prevented from undergoing the compositional change with time which is attributable to oligomer proportion in the adhesive layer, whereby long-lasting stable quality can be obtained. In case where the proportion of the polyfunctional acrylate oligomer and/or monomer is 10 parts by weight or smaller per 100 parts by weight of the base polymer in the adhesive layer, this adhesive layer undesirably is too hard before irradiation with ultraviolet. This poses a problem that when the adhesive sheet is applied to a wafer having differences in level, this adhesive sheet is less apt to conform to the level differences.

Examples of the polyfunctional ingredient include (meth)acrylate oligomers and monomers. Specific examples thereof include hexanediol di(meth)acrylate, (poly)ethylene glycol di(meth)acrylate, 1,4-butanediol di(meth)acrylate, (poly)propylene glycol di(meth)acrylate, neopentyl glycol di(meth)acrylate, pentaerythritol di(meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, epoxy(meth)acrylates, polyester(meth)acrylates, and urethane(meth)acrylates. Examples of the polyfunctional ingredient further include oligomers of various kinds including urethane, polyether, polyester, polycarbonate, and polybutadiene oligomers. An adequate range of the molecular weights (weight-average molecular weights) of these oligomer ingredients is about from 100 to 30,000. These ingredients may be used alone or in combination of two or more thereof.

In particular, preferred urethane(meth)acrylate oligomers are ones having two to four, desirably two acryloyl groups in the molecule. Such an oligomer can be produced, for example, by a method in which a diisocyanate is first reacted with a polyol in a reaction vessel kept at 60° C. to 90° C. and, after completion of the reaction, a hydroxy(meth)acrylate is added thereto and further reacted.

Examples of the diisocyanate include toluene diisocyanate, diphenylmethane diisocyanate, hexamethylene diisocyanate, phenylene diisocyanate, dicyclohexylmethane diisocyanate, xylene diisocyanate, tetramethylxylene diisocyanate, and naphthalene diisocyanate.

Examples of the polyol include ethylene glycol, propylene glycol, butanediol, and hexanediol.

Examples of the hydroxy(meth)acrylate include 2-hydroxyethyl(meth)acrylate and 2-hydroxypropyl(meth)acrylate.

Such examples of each ingredient may be used alone or in combination of two or more thereof.

Examples of methods for blending these polyfunctional acrylate oligomers and/or monomers so as to result in a weight-average molecular weight per carbon-carbon double bond of 250 to 6,500 include a method in which the following calculation equations are used to suitably select and/or blend polyfunctional acrylate oligomers and/or monomers so as to result in a weight-average molecular weight per carbon-carbon double bond within that range.

In the case of one polyfunctional oligomer and/or monomer:

M=(M_{w}/N_{dou}) (1)

In the case of using a blend of two polyfunctional oligomers and/or monomers (e.g., monomer M1 and oligomer O2):

M=[(M_{w} of M1)/(N_{dou} of M1)]×[(Wp of M1)/(total Wp of M1 and O2)]+[(M_{w} of O2)/(N_{dou} of O2]×[(Wp of O2)/(total Wp of M1 and O2)] (2)

(In the equations, M represents weight-average molecular weight per carbon-carbon double bond; Mw represents weight-average molecular weight; N_{dou} represents number of carbon-carbon double bonds; and Wp represents amount in parts by weight.)

In the case of blending three or more polyfunctional oligomers and/or monomers, a proportion can be calculated according to the case described above in which two polyfunctional oligomers and/or monomers are used.

One or more ingredients suitably selected from tackifiers, softeners, antioxidants, hardeners, fillers, ultraviolet absorbers, light stabilizers, (photo)polymerization initiators, and the like may be added to the adhesive layer in the invention. With respect to each of these kinds of additives, one ingredient may be used alone or two or more ingredients may be used in combination.

For example, preferred tackifiers for use here are ones having a hydroxyl value of from 120 mg/g to 230 mg/g. More preferred are ones having a hydroxyl value of from 120 mg/g to 210 mg/g. By using a tackifier having a hydroxyl value regulated to that value, sufficient adhesiveness can be imparted to the adhesive before irradiation with ultraviolet. Furthermore, the adhesive force of the adhesive layer containing such tackifier can be reduced to a desired value through ultraviolet irradiation regardless of the kinds of the adhesive and other ingredients on the application side of the adhesive sheet or regardless of the amount of a release agent added or adhered to the surface of the adhesive layer.

Examples of the tackifiers containing hydroxyl groups and having a specific hydroxyl value include terpene phenol resins, rosin phenol resins, and alkylphenol resins. Examples of the terpene phenol resins include α-pinene/phenol resins, β-pinene/phenol resins, dipentene/phenol resins, and terpene/bisphenol resins. By using a terpene phenol resin, high compatibility with the base polymer is obtained. Accordingly, the adhesive sheet undergoes almost no change in adhesive during storage and can retain stable quality over long. Usually, a tackifier having a lower molecular weight (weight-average molecular weight) than the base polymer is used. Examples thereof include ones having a molecular weight of about tens of thousands or lower, preferably about 10,000 or lower, more preferably about several thousands or lower.

It is preferred that a tackifier should be used in an amount of from 0.1 part by weight to 70 parts by weight, more preferably from 1 part by weight to 50 parts by weight, per 100 parts by weight of the base polymer. By incorporating a tackifier in such an amount, adhesive force can be suitably increased and the storage stability of the adhesive sheet can be ensured. Thus, stable properties can be obtained over long.

Examples of the softeners include plasticizers, polybutene, liquid tackifier resins, polyisobutylene having a low polymerization degree, poly(vinyl isobutyl ether) having a low polymerization degree, lanolin, depolymerized rubbers, and process oils or vulcanization oils.

Examples of the antioxidants include phenolic antioxidants (e.g., 2,6-di-t-butyl-4-methylphenol and 1,1-bis(4-hydroxyphenyl)cyclohexane), amine type antioxidants (e.g., phenyl-β-naphthylamine), benzimidazole type antioxidants (e.g., mercaptobenzimidazole), and 2,5-di-t-butylhydroquinone.

Examples of hardeners for rubber-based adhesives include isocyanates, sulfur and vulcanization accelerators, polyalkylphenols, and organic peroxides. Examples of the isocyanates include phenylene diisocyanate, tolylene diisocyanate, diphenylmethane diisocyanate, hexamethylene diisocyanate, and cyclohexane diisocyanate. Examples of the sulfur and vulcanization accelerators include thiazole type vulcanization accelerators, sulfenamide type vulcanization accelerators, thiuram type vulcanization accelerators, and dithioic acid salt type vulcanization accelerators. Examples of the polyalkylphenols include butylphenol, octylphenol, and nonylphenol. Examples of the organic peroxides include dicumyl peroxide, ketone peroxides, peroxyketals, hydroperoxides, dialkyl peroxides, peroxyesters, and peroxydicarbonates.

Examples of the fillers include zinc white, titanium oxide, silica, aluminum hydroxide, calcium carbonate, barium sulfate, starch, clay, and talc.

Photopolymerization initiators function to be excited and activated by irradiation with ultraviolet to generate a radical and thereby cure the polyfunctional oligomer through radical polymerization. Examples thereof include acetophenone type photopolymerization initiators such as 4-phenoxydichloroacetophenone, 4-t-butyldichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)phenyl (2-hydroxy-2-propyl)ketone, 1-hydroxycyclohexyl phenyl ketone, and 2-methyl-1-[4-(methylthio)phenyl]-2-morpholinopropane-1; benzoin type photopolymerization initiators such as benzoin, benzoin methyl ether, benzoin ethyl ether, benzoin isopropyl ether, benzoin isobutyl ether, and 2,2-dimethoxy-2-phenylacetophenone; benzophenone type photopolymerization initiators such as benzophenone, benzoylbenzoic acid, methyl benzoylbenzoate, 4-phenylbenzophenone, hydroxybenzophenone, 4-benzoyl-4′-methyldiphenyl sulfide, and 3,3′-dimethyl-4-methoxybenzophenone; thioxanthone type photopolymerization initiators such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; and special photopolymerization initiators such as α-acyloxymesters, acylphosphine oxides, methylphenyl glyoxylate, benzil, camphorquinone, dibenzosuberone, 2-ethylanthraquinone, and 4′,4″-diethylisophthalophenone.

It is preferred that the proportion of the photopolymerization initiator to be incorporated should be from 0.1 part by weight to 15 parts by weight, especially from 0.5 parts by weight to 10 parts by weight, per 100 parts by weight of the base polymer. In case where the proportion of the photopolymerization initiator incorporated is too small, the effect of curing the polyfunctional oligomer or monomer by irradiation with ultraviolet and/or a radiation is poor, resulting in an insufficient decrease in adhesive force. In case where the proportion thereof is too large, the adhesive shows poor stability when heated or in the light of a fluorescent lamp.

Examples of polymerization initiators include peroxides such as hydrogen peroxide, benzoyl peroxide, and t-butyl peroxide. Although it is desirable to use such a peroxide alone, a combination of a peroxide and a reducing agent may be used as a redox polymerization initiator. Examples of the reducing agent include sulfurous acid salts, hydrogen sulfites, ionizable salts such as iron, copper, and cobalt salts, amines such as triethanolamine, and reducing sugars such as aldoses and ketoses. Furthermore, use may be made of azo compounds such as 2,2′-azobis-2-methylpropioamidine acid salts, 2,2′-azobis-2,4-dimethylvaleronitrile, 2,2′-azobis-N,N′-dimethyleneisobutyroamidine acid salts, 2,2′-azobisisobutyronitrile, and 2,2′-azobis-2-methyl-N-(2-hydroxyethyl)propionamide. These compounds may be used alone or in combination of two or more thereof.

Examples of methods for forming an adhesive layer on a substrate to produce an adhesive sheet for semiconductor wafer back grinding in the invention include a method in which the ingredients for forming the adhesive layer are applied, by themselves or after dissolved in an appropriate organic solvent, to a substrate by coating fluid application, spraying, etc. and the ingredients applied are dried, for example, by conducting a heat treatment at, e.g., 80° C. to 100° C. for about from 30 seconds to 10 minutes.

In the invention, the thickness of the adhesive layer is preferably from 3 μm to 150 μm, more preferably from 5 μm to 120 μm. Even when applied to an adherend having a high surface roughness, the adhesive sheet in which the thickness of the adhesive layer has been regulated to a value within that range can conform to the surface irregularities, so that the back grinding of the adherend can be conducted stably. Furthermore, a reduction in production cost can be attained.

It is also desirable that this adhesive should be regulated so as to have an initial modulus of elasticity of from 0.03 MPa to 0.5 MPa. When the initial modulus of elasticity of the adhesive is within that range, this adhesive can conform to wafer patterns having irregularities and the back grinding of adherends can be stably conducted. In case where the initial modulus of elasticity of the adhesive is lower than 0.03 MPa, this poses practical problems, for example, that the adhesive layer protrudes when the sheet is wound into a roll or cut with a cutter or the like.

The adhesive sheet of the invention for the back grinding of a semiconductor wafer can be applied in the following manner. The sheet is superposed on the front side (the side where a circuit pattern has been formed) of a semiconductor wafer so that the surface of the adhesive layer faces the wafer front side, and this sheet is applied thereto while pressing the sheet against the wafer.

Specific examples of the procedure include (i) a method which includes placing a wafer on a table, superposing the adhesive sheet of the invention thereon so that the adhesive layer faces the wafer, and applying the adhesive sheet to the wafer while pressing the sheet with a pressing device, e.g., a pressing roller. Use may also be made of (ii) a method in which the sheet is superposed on a wafer in a vessel capable of pressurization (e.g., an autoclave) in the manner described above and the inside of the vessel is pressurized to thereby apply the sheet to the wafer. In this method, the sheet may be applied while pressing the sheet with a pressing device. Furthermore, (iii) the adhesive sheet may be applied in a vacuum chamber in the same manner as described above. When the adhesive sheet is applied by any of these methods, heating at about 30° C. to 150° C. may be conducted. Methods of application should not be construed as being limited to those examples.

After the grinding of the semiconductor wafer, the sheet applied is stripped off manually or with a machine. Since the adhesive layer employs a radiation-curable adhesive, the adhesive force of the adhesive layer decreases upon irradiation with a suitable radiation before stripping. Thus, the adhesive sheet can be easily stripped off advantageously.

### EXAMPLES

The invention will be explained below in more detail by reference to Examples of the adhesive sheet for semiconductor wafer back grinding of the invention and Comparative Examples. However, the invention should not be construed as being limited to the following Examples.

Standard Wafer

A pattern-bearing wafer was designed which was constituted of a wafer coated with aluminum by vapor deposition and having an average surface roughness Ra of 50 nm and ink dots having a height of from 20 μm to 30 μm and a diameter of 200 μm formed on the wafer at a pitch of 200 μm. This pattern-bearing wafer was used as a standard adherend for the evaluation of the invention.

Application

Each adhesive sheet was produced under the conditions shown later, and the adhesive sheet was applied to the standard wafer with DR-8500II, manufactured by Nitto Seiki Inc., at a rate of 20 mm/sec and a table temperature of 20° C. This procedure corresponds to method (i) described above (the method including placing the standard wafer on a table, superposing the sheet of the invention thereon so that the adhesive layer (2) faced the wafer, and applying the sheet to the wafer while pressing the sheet with a pressing device such as a pressing roller).

Wafer Back Grinding

The standard wafer to which the adhesive sheet had been applied by the method given above was ground to a thickness of 200 μm with silicon wafer grinder DFG840, manufactured by Disco Corp.

Sheet Stripping

The standard wafer which had been ground by the method given above was subjected to the stripping of the adhesive sheet with DR-8500II, manufactured by Nitto Seiki Inc. Specifically, after the wafer grinding, the adhesive sheet was irradiated with ultraviolet at 460 mJ/cm² to cure the adhesive layer. Subsequently, a stripping tape was applied to this adhesive sheet, which was then stripped off together with the tape.

Evaluation Methods

(Substitute Evaluation of Conformability to Level Difference)

The following method was used as a substitute for the evaluation of conformability to level differences in sheet application to an adherend surface having irregularities such as those of, e.g., a circuit. One tape having a width of 20 mm and a thickness of 30 μm (tape for level difference formation) was applied to a surface of a silicon mirror wafer. Thereafter, a sample tape having a width of 20 mm was applied with a 2-kg roller so as to cross the tape for level difference formation. The non-contact regions which were formed at the intersection of the tape for level difference formation and the sample tape were examined with a microscope (magnification, 100 diameters). When the non-contact regions had a width in the sample tape application direction of 0.5 mm or smaller, this sample tape was regarded as satisfactory in conformability to level difference.

(Evaluation for Adhesive Residue)

After tape stripping, the surface of the standard wafer was examined for an adhesive residue thereon with an optical microscope. The area of the adhesive residue observed in an arbitrary range of 1 cm×1 cm in the surface of the standard wafer was measured to calculate the proportion of the adhesive residue.

(Evaluation of Adhesive Force Stability)

The long-term stability of an adhesive layer was examined by the following method. Sample sheets were stored respectively under the following sets of conditions: at 60° C. for 1 week; at 40° C. and a relative humidity of 92% for 1 week; and at 10° C. for 1 week. Thereafter, the sample sheets were examined for adhesive force. The initial value of adhesive force of the sample is taken as 100%, and the case where all the values of adhesive force determined after the storage under all sets of conditions were 100±30% is regarded as satisfactory in stability (good). The case where the value of adhesive force after the storage under at least one set of conditions was lower than 70% or higher than 130% was regarded as poor in stability (poor).

### Example 1

A copolymer having a weight-average molecular weight of 700,000 (solid content, 35%) was obtained by copolymerizing 40 parts by weight of methyl acrylate, 10 parts by weight of acrylic acid, and 60 parts by weight of 2-ethylhexyl acrylate. Then, 50 parts by weight of UV-3000B (weight-average molecular weight, 18,000; number of double bonds, 2) and 50 parts by weight of UV-1700B (weight-average molecular weight, 2,000; number of double bonds, 10), both manufactured by Nippon Synthetic Chemical Industry Co., Ltd., were added as polyfunctional acrylate oligomers (weight-average molecular weight per double bond of the polyfunctional-oligomer solution prepared, 4,600) to 100 parts by weight of the copolymer prepared as above. Thereto were added 0.02 parts by weight of an alkylphosphoric ester surfactant (trade name “Phosphanol RL-210”, manufactured by Toho Chemical Industry Co., Ltd.; number of carbon atoms in the alkyl group, 18), 1.00 part by weight of an isocyanate crosslinking agent (trade name “Coronate L”, manufactured by Nippon Polyurethane Co., Ltd.) as a crosslinking agent, 0.1 parts by weight of an epoxy crosslinking agent (trade name “Tetrad C”, manufactured by Mitsubishi Gas Chemical Co., Ltd.) as another crosslinking agent, and 3 parts by weight of a photopolymerization initiator (trade name “Irgacure 651”, manufactured by Ciba Specialty Chemicals Co.). Thus, an adhesive solution for forming an adhesive layer was prepared. This solution was applied in a thickness of 50 μm on a dry basis to a polyester film having a thickness of 38 μm which had been treated with a silicone releasant, and the coating was dried at 120° C. for 2 minutes. Thereafter, a 115-μm polyethylene film serving as a substrate was laminated thereto to produce an adhesive sheet for semiconductor wafer back grinding. The adhesive sheet for semiconductor wafer back grinding thus obtained was aged with heating at 50° C. for 1 day or more and then subjected to the evaluation described above. The results of the evaluation are shown in Table 1.

### Example 2

An adhesive sheet was produced in the same manner as in Example 1, except that 70 parts by weight of UV-3000B and 30 parts by weight of UV-1700B (weight-average molecular weight per double bond of the polyfunctional-oligomer solution prepared, 6,360) were added in the preparation of an adhesive solution in Example 1.

### Example 3

An adhesive sheet was produced in the same manner as in Example 1, except that 10 parts by weight of UV-3000B and 90 parts by weight of UV-1700B (weight-average molecular weight per double bond of the polyfunctional-oligomer solution prepared, 1,080) were added in the preparation of an adhesive solution in Example 1.

### Example 4

An adhesive sheet was produced in the same manner as in Example 1, except that 50 parts by weight of UV-3000B and 50 parts by weight of UV-1700B (weight-average molecular weight per double bond of the polyfunctional-oligomer solution prepared, 4,600) were added in the preparation of an adhesive solution in Example 1, and that 10 parts by weight of the alkylphosphoric ester surfactant (trade name “Phosphanol RL-210”, manufactured by Toho Chemical Industry Co., Ltd.; number of carbon atoms in the alkyl group, 18) was added in the preparation.

### Example 5

An adhesive sheet was produced in the same manner as in Example 1, except that 80 parts by weight of UV-6300B (weight-average molecular weight, 3,700; number of double bonds, 7) (weight-average molecular weight per double bond of the polyfunctional-oligomer solution prepared, 530) was added in the preparation of an adhesive solution in Example 1.

### Comparative Example 1

An adhesive sheet was produced in the same manner as in Example 1, except that 50 parts by weight of UV-3000B and 50 parts by weight of UV-1700B (weight-average molecular weight per double bond of the polyfunctional-oligomer solution prepared, 4,600) were added in the preparation of an adhesive solution in Example 1, and that 0.01 part by weight of the alkylphosphoric ester surfactant (trade name “Phosphanol RL-210”, manufactured by Toho Chemical Industry Co., Ltd.; number of carbon atoms in the alkyl group, 18) was added in the preparation.

### Comparative Example 2

An adhesive sheet was produced in the same manner as in Example 1, except that 100 parts by weight of UV-1700B (weight-average molecular weight, 2,000; number of double bonds, 10) (weight-average molecular weight per double bond of the polyfunctional-oligomer solution prepared, 200) was added in the preparation of an adhesive solution in Example 1.

### Comparative Example 3

An adhesive sheet was produced in the same manner as in Example 1, except that 80 parts by weight of UV-3000B and 20 parts by weight of UV-1700B (weight-average molecular weight per double bond of the polyfunctional-oligomer solution prepared, 7,240) were added in the preparation of an adhesive solution in Example 1.

### Comparative Example 4

An adhesive sheet was produced in the same manner as in Example 1, except that 120 parts by weight of UV-3000B and 120 parts by weight of UV-1700B (weight-average molecular weight per double bond of the polyfunctional-oligomer solution prepared, 4,600) were added in the preparation of an adhesive solution in Example 1, and that 11 parts by weight of the alkylphosphoric ester surfactant (trade name “Phosphanol RL-210”, manufactured by Toho Chemical Industry Co., Ltd.; number of carbon atoms in the alkyl group, 18) was added in the preparation.

### Comparative Example 5

An adhesive sheet was produced in the same manner as in Example 1, except that 5 parts by weight of UV-3000B and 5 parts by weight of UV-1700B (weight-average molecular weight per double bond of the polyfunctional-oligomer solution prepared, 4,600) were added in the preparation of an adhesive solution in Example 1.

The adhesive sheets produced in the Examples and Comparative Examples were subjected to the evaluation described above. The results obtained are shown in Table 1 and Table 2.

TABLE 1

| | Example 1 | Example 2 | Example 3 | Example 4 | Example 5 |
|---|---|---|---|---|---|
| UV-3000B | 50 | 70 | 10 | 50 | 0 |
| (parts) | | | | | |
| UV-1700B | 50 | 30 | 90 | 50 | 0 |
| (parts) | | | | | |
| UV-6300B | 0 | 0 | 0 | 0 | 80 |
| (parts) | | | | | |
| Weight- | 4600 | 6360 | 1080 | 4600 | 529 |
| average | | | | | |
| molecular | | | | | |
| weight per | | | | | |
| C = C | | | | | |
| Phosphoric | 0.02 | 0.02 | 0.02 | 10.00 | 0.02 |
| ester | | | | | |
| compound | | | | | |
| (parts) | | | | | |
| Width of | 0.21 | 0.25 | 0.19 | 0.20 | 0.24 |
| lifting due | | | | | |
| to level | | | | | |
| difference | | | | | |
| (mm) | | | | | |
| Adhesive | 0.1% | 0.8% | 0.2% | 0.0% | 0.5% |
| residue | | | | | |
| Stability of | good | good | good | good | good |
| adhesive | | | | | |
| force | | | | | |

TABLE 2

| | Com- | Com- | Com- | Com- | Com- |
|---|---|---|---|---|---|
| | parative | parative | parative | parative | parative |
| | Example 1 | Example 2 | Example 3 | Example 4 | Example 5 |
| UV-3000B | 50 | 0 | 80 | 120 | 5 |
| (parts) | | | | | |
| UV-1700B | 50 | 100 | 20 | 120 | 5 |
| (parts) | | | | | |
| UV-6300B | 0 | 0 | 0 | 0 | 0 |
| (parts) | | | | | |
| Weight- | 4600 | 200 | 7240 | 4600 | 4600 |
| average | | | | | |
| molecular | | | | | |
| weight per | | | | | |
| C = C | | | | | |
| Phosphoric | 0.01 | 0.02 | 0.02 | 11.00 | 0.02 |
| ester | | | | | |
| compound | | | | | |
| (parts) | | | | | |
| Width of | 0.20 | 0.16 | 0.35 | 0.2 | 1.5 |
| lifting due | | | | | |
| to level | | | | | |
| difference | | | | | |
| (mm) | | | | | |
| Adhesive | 8.30% | 100.0% | 98.0% | 0.0% | 0.2% |
| residue | | | | | |
| Stability of | good | good | good | poor | good |
| adhesive | | | | | |
| force | | | | | |

Table 1 shows the followings. In each of the ultraviolet-curable adhesive sheets obtained in Examples 1 to 5, the weight-average molecular weight per carbon-carbon double bond of the polyfunctional acrylate oligomer(s) and/or monomer(s) in the adhesive layer is a suitable value and a phosphoric ester has been incorporated in the adhesive layer in a suitable amount. Because of this, those adhesive sheets applied to an adherend show a low proportion of adhesive residue after ultraviolet irradiation and subsequent stripping thereof. Furthermore, those adhesive sheets are satisfactory in the long-term stability of adhesive force.

In addition, in each of the ultraviolet-curable adhesive sheets obtained in Examples 1 to 5, the amount of the polyfunctional acrylate oligomer(s) and/or monomer(s) relative to the amount of the base polymer in the adhesive layer is suitable. Because of this, in the substitute evaluation of conformability to level difference, the width of the regions which have lifted due to level difference is 0.5 mm or smaller in each adhesive sheet. These adhesive sheets have satisfactory conformability to irregularities, e.g., circuits, on wafer surfaces.

In contrast, the ultraviolet-curable adhesive sheet of Comparative Example 1 is apt to leave an adhesive residue upon stripping after ultraviolet irradiation because the amount of the phosphoric ester compound incorporated in the adhesive is too small.

In the ultraviolet-curable adhesive sheet of Comparative Example 2, the polyfunctional acrylate oligomer and/or monomer in the adhesive layer has too low a weight-average molecular weight per carbon-carbon double bond. Because of this, the adhesive after ultraviolet irradiation is too hard and this adhesive is apt to break when the adhesive sheet is stripped off, resulting in an adhesive residue. In the ultraviolet-curable adhesive sheet of Comparative Example 3, the polyfunctional acrylate oligomers and/or monomers in the adhesive layer have too high a weight-average molecular weight per carbon-carbon double bond. Because of this, the adhesive after ultraviolet irradiation is in an insufficiently cured state and the stripping of this adhesive sheet is apt to result in an adhesive residue.

In the ultraviolet-curable adhesive sheet of Comparative Example 4, the amount of the phosphoric ester compound incorporated in the adhesive is too large and the amount of the polyfunctional acrylate oligomers and/or monomers incorporated, relative to the amount of the base polymer in the adhesive layer, is also too large. Because of this, the long-term stability of adhesive force is poor.

Furthermore, in the ultraviolet-curable adhesive sheet obtained in Comparative Example 5, the amount of the polyfunctional acrylate oligomers and/or monomers incorporated, relative to the amount of the base polymer in the adhesive layer, is too small. Because of this, this adhesive layer is already hard in the stage of application to a wafer. This adhesive sheet hence has a problem that when applied to a wafer having a difference in level, the adhesive sheet is less apt to conform to the level difference.

As apparent from the explanation given above, the ultraviolet-curable adhesive sheet of the invention, even when applied to a wafer having irregularities, e.g., circuits, on the surface, can fix the wafer while adhering to the irregularities with satisfactory conformability thereto. The back side of the wafer thus fixed can be ground. Irradiation of this adhesive sheet with ultraviolet after the back grinding enables the adhesive sheet to be stripped off without leaving an adhesive residue. Furthermore, the adhesive has satisfactory long-term stability.

While the present invention has been described in detail and with reference to specific embodiments thereof, it will be apparent to one skilled in the art that various changes and modifications can be made therein without departing from the scope thereof.

This application is based on Japanese patent application No. 2008-161396 filed on Jun. 20, 2008, the entire contents thereof being hereby incorporated by reference.

What is claimed is:

1. A method of grinding a back side of a semiconductor wafer, which comprises applying an adhesive sheet comprising a substrate and an adhesive layer formed on one side of the substrate to a front side of a semiconductor wafer to provisionally fix the semiconductor wafer to the adhesive sheet, followed by grinding the back side of the semiconductor wafer,
wherein the adhesive layer comprises 100 parts by weight of a base polymer for radiation-curable adhesives, 0.02 to 10 parts by weight of a phosphoric ester compound having an alkyl group having 10 or more carbon atoms, and more than 10 parts by weight but 200 parts by weight or less of at least one polyfunctional acrylate oligomer and/or monomer having one or more carbon-carbon double bonds, the polyfunctional acrylate oligomer and/or monomer having a weight-average molecular weight per carbon-carbon double bond of 250 to 6,500.

2. The method according to claim 1, wherein the phosphoric ester compound contained in the adhesive layer has a linear alkyl group having 15 to 60 carbon atoms.

3. The method according to claim 1, wherein the phosphoric ester compound contained in the adhesive layer has a melting point of 40° C. to 110° C.

4. The method according to claim 1, wherein the front side of the semiconductor wafer has a pattern of irregularities with a height difference of from 1 μm to 30 μm and has fine recesses and protrusions having a surface roughness of from 30 nm to 100 nm.

5. An adhesive sheet for use in the method according to claim 1.
